(19) United States
(12) Patent Application Publication
(10) Pub. No.: US 2025/0392042 A1
(43) Pub. Date: Dec. 25, 2025

(54) BEAMFORMER

(71) Applicant: NTT, Inc., Tokyo (JP)

(72) Inventors: Adam Pander, Tokyo (JP); Daisuke Kitayama, Tokyo (JP)

(21) Appl. No.: 19/118,228

(22) PCT Filed: Oct. 6, 2022
(86) PCT No.: PCT/JP2022/037413

§ 371 Date: Apr. 3, 2025

(51) Int. Cl. H01Q 3/36

(52) U.S. Cl. CPC H01Q 3/36

(57) ABSTRACT

An embodiment is a beamformer for directing an incident electromagnetic wave, including a first conductive metamaterial cell configured to shift a phase of a first portion of the electromagnetic wave, a second conductive metamaterial cell located adjacent to the first conductive metamaterial cell, having a different geometry than the first conductive metamaterial cell, and configured to shift a phase of a second portion of the electromagnetic wave, a conductor including at least a portion disposed between the first conductive metamaterial cell and the second conductive metamaterial cell.

### CROSS-REFERENCE TO RELATED APPLICATIONS

This application is a national phase entry of PCT Application No. PCT/JP2022/037413, filed on Oct. 6, 2022, which application is hereby incorporated herein by reference.

### TECHNICAL FIELD

The present invention relates to beamformer.

### BACKGROUND

Beamforming is implemented to achieve a well-defined radiation beam in the desired direction by precisely aligning the phases of the incoming electromagnetic (EM) wave from different parts of an array. Beamforming based on metamaterial structures has been studied as such beamforming (NPL 1).

Metamaterials are artificial materials that obtain their properties from subwavelength cells organized together to imitate the structure of atoms in natural materials. Metamaterials can manipulate the EM wave by the control of various properties, such as refractive index, permeability, and permittivity at the desired frequency range. The unique properties of metamaterials are originated from the geometry (including size), and arrangement of the periodic metamaterial cells, and also from the properties of the material that consists of these structures.

### CITATION LIST

### Non Patent Literature

[NPL 1]
Iyemeh Uchendu and James R. Kelly, “Survey of Beam Steering Techniques Available for Millimeter Wave Applications,” Progress In Electromagnetics Research B, Vol. 68, 35-54, 2016. doi: 10.2528/PIERB16030703

### SUMMARY

Though metamaterial-based beamformers are one of the main choices to steer the EM beam, their design still creates many challenges, especially with the increase in the operating frequency.

In typical case, the metamaterial cells that exhibit different phase shift amounts are designed separately and then combined into a beamformer. To realize phase shift in the metamaterials, the geometries of the metamaterial cells are usually tuned to exhibit desired phase shift amounts, keeping low transmission losses at the same time. This leads to the arrangement in which metamaterial cells with different phase shift amounts are grouped together in the beamformer to fulfill the phase step-change requirement. Since the metamaterial cells are designed separately in the infinite array of identical cells, the arrangement of cells having different geometry causes disturbances of the capacitance between neighbor cells, leading to the phase deviation in the beamformer, which produces different waves (side lobes) that the one obtained in the simulation of separate cells.

Embodiments of the present invention has been made to reduce the disturbance of the capacitance between adjacent metamaterial cells of different geometry, thereby reducing side lobes.

### Solution to Problem

In order to solve the above problem, embodiments of the present invention include a beamformer for directing an incident electromagnetic wave, comprising a first conductive metamaterial cell configured to shift a phase of a first portion of the electromagnetic wave; a second conductive metamaterial cell located adjacent to the first conductive metamaterial cell, having a different geometry than the first conductive metamaterial cell, and configured to shift a phase of a second portion of the electromagnetic wave; and a conductor including at least a portion disposed between the first conductive metamaterial cell and the second conductive metamaterial cell.

According to the above configuration, the disturbance of the capacitance between the adjacent metamaterial cells of different geometry is reduced, thereby reducing sidelobes.

### BRIEF DESCRIPTION OF THE DRAWINGS

FIG. 1 is a schematic diagram of a beamformer of an embodiment.

FIG. 2 is a schematic diagram of the A-A cross-section of FIG. 1.

FIG. 3 shows variations in the geometry of the metamaterial cell.

FIG. 4 shows a schematic diagram of the transmission of EM wave.

FIG. 5 is a schematic diagram of a cross-section of a reflective beamformer.

FIG. 6 is a plan view of a metamaterial cell to illustrate various size parameters of the metamaterial cell.

FIG. 7 shows a plan view of metamaterial cells with an equivalent circuit superimposed.

FIG. 8 shows a plan view of metamaterial cells with an equivalent circuit superimposed.

FIG. 9 shows a plan view of metamaterial cells with an equivalent circuit superimposed.

FIG. 10 is a schematic diagram of the metamaterial cells and conductors used in the simulation.

FIG. 11 shows a graph of the total phase variation when the size (radius R) of the metamaterial cell is varied.

FIG. 12 shows the simulation results when EM wave is input to a beamformer without a conductor.

FIG. 13 shows the simulation results when EM wave is input to a beamformer with a conductor.

FIG. 14 shows a plan view of metamaterial cells with an equivalent circuit superimposed.

### DETAILED DESCRIPTION OF ILLUSTRATIVE EMBODIMENTS

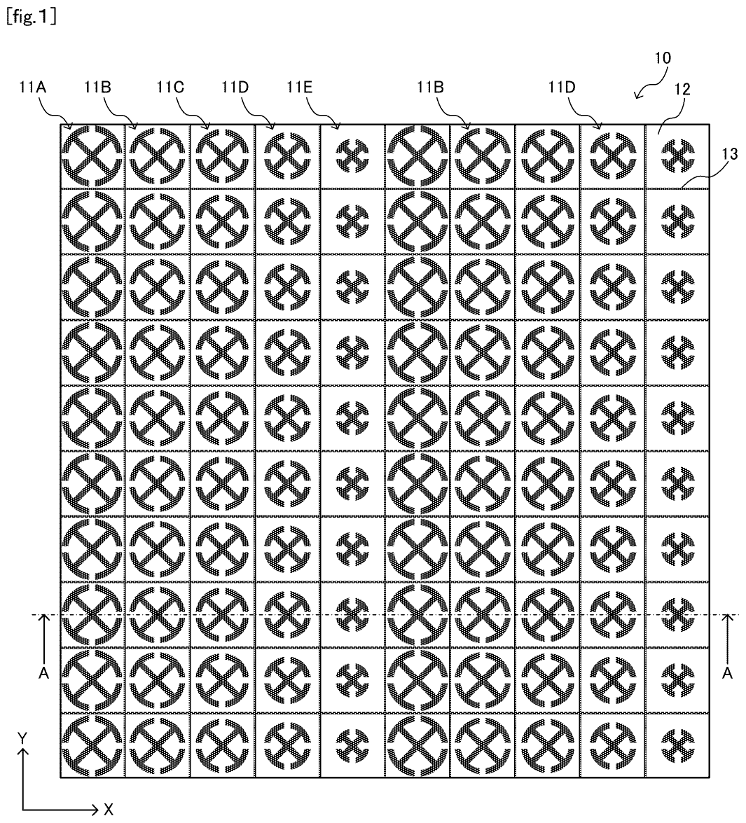

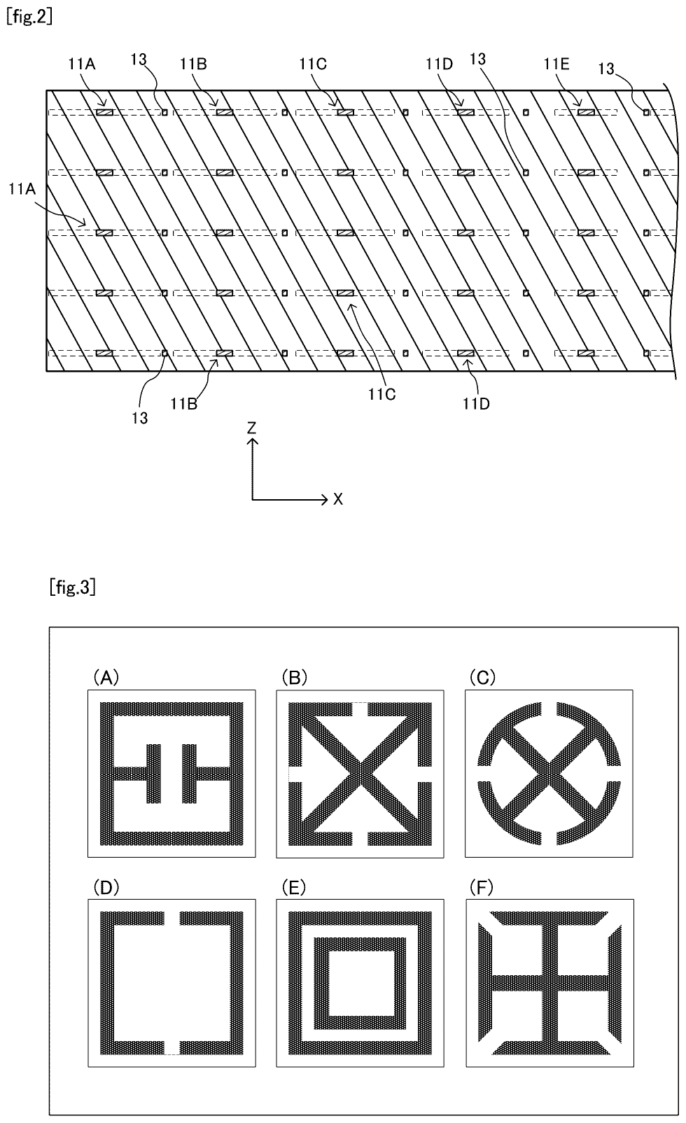

As shown in FIGS. 1 and 2, a beamformer 10 of this embodiment includes conductive metamaterial cells 11A to 11E, a filling dielectric material 12, and a conductor 13. The beamformer 10 is a transmission type that transmits the incident EM wave. The beam former 10 emits the transmitted EM wave as a directional electromagnetic wave in a desired direction.

Each of the conductive metamaterial cells 11A-11E is a subwavelength metamaterial cell. The conductive metamaterial cells 11A-11E are periodically arranged in the form of an array and designed to resonate at millimeter-wave frequencies (30-500 GHz). Hereafter, conductive metamaterial cells 11A-11E are simply referred to as cells 11A-11E, respectively. Cells 11A-11E are also collectively referred to as cell 11.

The cells 11 are fabricated from electrically conductive materials such as metals, high conductivity polymers, conductive oxides, or high electric conductivity carbon-based materials such as carbon nanotubes and graphene.

As shown in FIG. 1, the cells 11 are periodically arranged in an array, more specifically, in a matrix. The cells 11 as a whole constitute a passive array. In the X direction, cells 11 of different geometries with respect to each other are periodically arranged. For example, cells 11B is placed adjacent to cells 11A in the X direction, and cells 11C is placed adjacent to cells 11B. In the Y-direction, cells 11 with the same geometry are placed. For example, cells 11A are arranged in a row along the Y direction. Here, each row of cells 11A to 11E is arranged in two rows. A plurality of cells 11 in a row in the Y direction form a cell group.

As shown in FIG. 2, if the set of cells 11 arranged in the matrix, or planar arrangement, is one layer, the beamformer 10 has 5 layers. The number of layers can be one or more.

The geometries of the cells 11 may be formed in geometries that resonate at millimeter wave frequencies (30 to 500 GHz), as described above. Examples of the geometries of cells 11 are shown in FIG. 3. (A) is an electric resonator, (B) is a square Jerusalem cross, (C) is a round Jerusalem cross, (D) is a double split ring resonator, (E) is a square double loop, and (F) is a cross resonator. Here, the round Jerusalem cross in FIG. 3(c) is employed.

Returning to FIGS. 1 and 2, the cells 11A are formed to shift the phase of the incident EM wave incident to the area where the cell 11A of the beamformer 10 is provided by shift amount A. As described below, a cell 11A cooperates with the portion (frame 13A) of conductor 13 that surrounds thereof to shift the phase. Similarly, the cells 11B to 11E are formed in such a way that phases of incident EM waves are shifted by the shift amounts B to E, respectively. The shift amounts A to E is different from each other. Thus, the cells 11A to 11E have different geometries, in particular, different sizes from each other. Each EM wave phase-shifted by each of the cells 11A-11E is combined to form an outgoing EM wave from the beamformer 10. The beamformer 10 is a passive type.

Filling dielectric material 12 supports all the cells 11 and the conductor 13. The filling dielectric material 12 constitutes the bulk of the volume of the beam former 10. The filling dielectric material 12 can be fabricated from any type of non-conductive dielectric material such as polyimide (PI), benzocyclobutene (BCB), parylene, polyethylene (PE), polytetrafluoroethylene (PTFE), etc. Filling dielectric material 12 is used to fill the gaps between the cells 11, the gaps between the cells 11 and the conductors 13, and the gaps within the cells 11.

Each conductor 13 is provided in each layer where the arrayed cells 11 are provided, respectively. In other words, five conductors 13 are configured here. The conductor 13 is configured as a mesh surrounding each cell 11 one by one. The function of the conductors is described below.

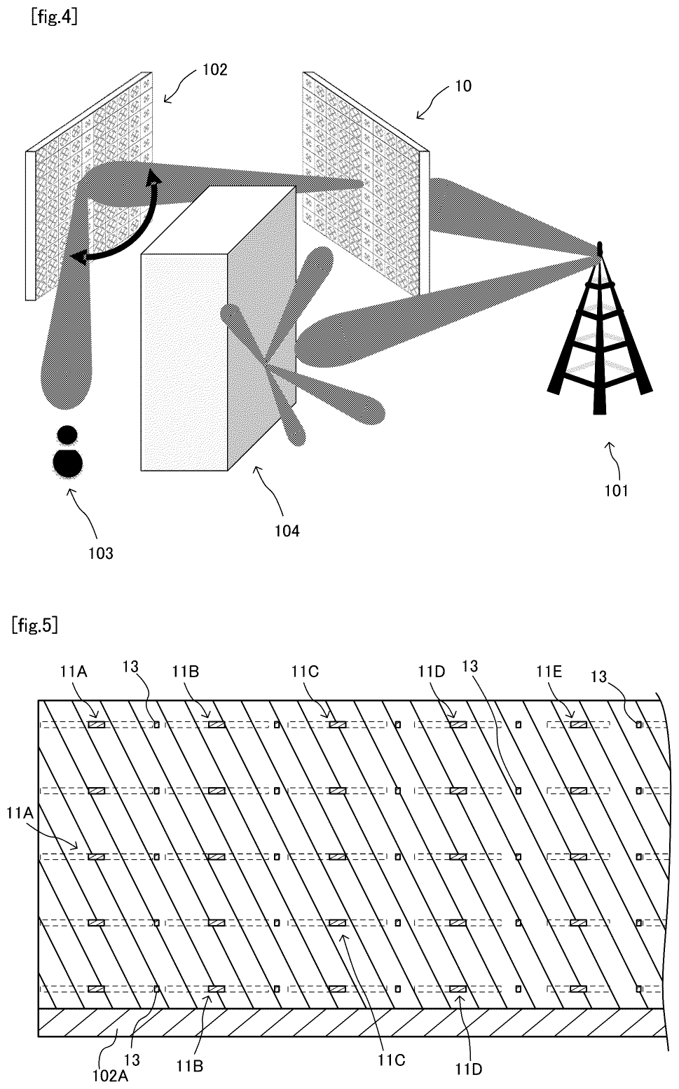

In this embodiment, as shown in FIG. 4, the radiating element 101, e.g., an antenna, radiates millimeter wave of a certain frequency. The wave is the incident EM wave to the beamformer 10. The EM wave incidents on the beamformer 10 and is transmitted through the beamformer 10. The beamformer 10 emits the transmitted EM wave in a directional manner in the desired direction. The emitted EM wave is received by a mobile terminal or other device of the user 103 via the beamformer 102, which is reflective type. As a result, the EM wave that cannot reach the user 103 directly due to obstacles 104 such as buildings are transmitted to the user 103.

The structure of FIGS. 1 and 2 of this embodiment may be applied to the reflective beamformer 102. In this case, as shown in FIG. 5, the beamformer 102 includes the above elements 11 to 13 as well as a conductive reflective layer 102A. The conductive reflective layer 102A is provided on the opposite side of the dielectric 12 to the EM wave incident surface.

The phase shift amount can be calculated for horizontal (azimuth) steering from equation 1 and for vertical (elevation) steering from equation 2. Where A—azimuth, E—elevation, p—period or distance between cells, andλ—wavelength of the incident wave (1 mm at 300 GHz).

$$\begin{matrix}[ Math . 1 ] & \\ {ψ}_{x} \frac{- 2 π \times p \times cos ( E ) \times sin ( A )}{λ} & ( 1 )\end{matrix}$$

$$\begin{matrix}[ Math . 2 ] & \\ {ψ}_{y} = \frac{- 2 π \times p \times sin ( E )}{λ} & ( 2 )\end{matrix}$$

The selection criteria for the cell 11 were based on the condition that the cell 11 can couple to the external electric (E) field generated from radiative elements, like antennas, to induce current flow in the conductive structure of the cell 11. In this embodiment, geometry (including size), period of cells 11 are optimized to achieve the desired frequency range, to be used at the millimeter-wave band. To achieve the excitation of the resonance, the size of the cell 11 is usually below λ/2 of the operating frequency. This embodiment introduces the additional conductor 13 to design of the cells 11 to separate the coupling capacitance between adjacent cells 11 and decrease its influence on the resonance generation in the cells 11.

The resonant frequency of the cell 11 can be calculated from the expression:

$$\begin{matrix}[ Math . 3 ] & \\ {f}_{R} = \frac{1}{2 π √ {\overline{LC}}_{e q}} ∝ \frac{1}{size} & ( 3 )\end{matrix}$$

Where L is the equivalent inductance and C_{eq} is the equivalent capacitance of the cell 11.

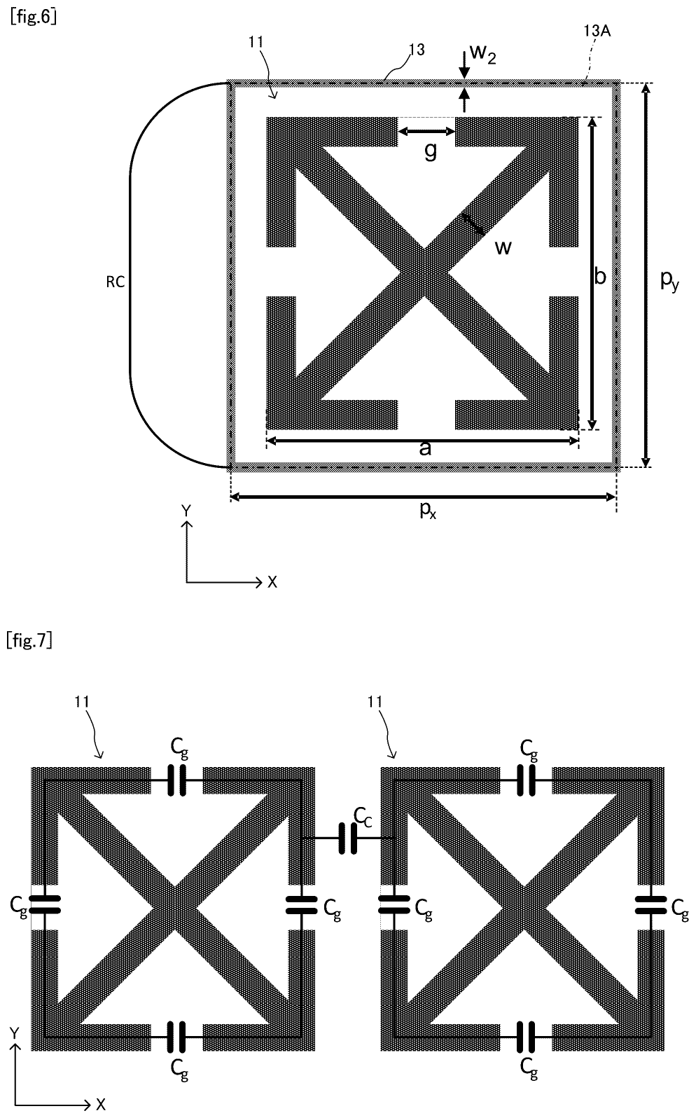

The equivalent inductance L is expressed as follows:

$$\begin{matrix}[ Math . 4 ] & \\ L = \frac{{μ}_{0} a b}{t} ∝ size & ( 4 )\end{matrix}$$

Where μₒ is the permeability of free space, α and b (FIG. 6) are the sizes of the cell 11 (with an assumption of a rectangular or square cell), tis the thickness of the cell 11. If cell 11 is circular, the above “ab” is πR² (R is the radius).

The equivalent capacitance Ceq in this embodiment is composed of the gap capacitance Cg and the coupling capacitance CC between adjacent cells 11, and can be generally expressed as follows:

$$\begin{matrix}[ Math . 5 ] & \\ {C}_{e q} = {C}_{g} + {C}_{L} & ( 5 )\end{matrix}$$

$${C}_{g} = \frac{{ε}_{0} {ε}_{c} w t}{g} ∝ size \qquad ( 6 )$$

$${C}_{C} = \frac{{ε}_{0} {ε}_{c} at}{d} ∝ size \qquad ( 7 )$$

Where εₒ and ε_{c} are permittivities of free space and effective permittivity of the material in between the gaps of the capacitor (filling dielectric material 12 in this embodiment), w (FIG. 6) is the width of the conductive portion of the cell 11, g (FIG. 6) is the gap length (width) in the cell 11, and d is the distance between the adjacent cells 11. Since C_{eq} and L are proportional to the size of the cell 11, the resonance frequency is inversely proportional to the size.

The schematic of the cell 11 with the additional conductor 13 and superimposed geometrical parameters is shown in FIG. 6. A resonant cell Z in FIG. 6 includes a frame 13A that surrounds cell 11 of the conductor 13 and this cell 11. The distance between the cells 11 (cell period) is px and py in X and Y-directions, respectively. The size of the cell 11 is a and b, in the X and Y-direction, respectively. The width of the conductive portion of the cell 11 is w, the gap size is g, and the width of the conductor 13 is w2. The conductor 13 is placed between the cells 11, so the symmetry line is in the middle of the conductor 13, in each direction. It means that the region having width w2/2 of the conductor 13, that is one frame 13A, contributes to one resonant cell Z and the region having another width w2/2, that is the other frame 13A, contributes to different neighbor resonant cell Z. The geometry of cell 11 in FIG. 6 differs from that of cell 11 in FIG. 1, but the concept in both is same.

FIG. 7 shows the schematic of two adjacent cells 11 without the conductor 13 with a superimposed equivalent electric circuit. The gap capacitance Cg of the designed cell 11 and the coupling capacitance CC between the cells 11 are shown. During the typical design process of the metamaterial cell, the simulation with infinite boundaries is carried out, and the results like resonance frequency peaks, phase shift amount at a certain operating frequency, etc. are obtained with the coupling effect between adjacent cells 11 and the capacitance CC. In the design and simulation of various sizes of cells 11 to achieve phase shift, the same phenomena occur; however, since the distance between cells 11 is different the capacitance CC between the cells 11 also varies. Therefore, when cells 11 of different sizes (geometry) are employed as described above, a disturbance in the coupling capacitance between the cells 11 occurs.

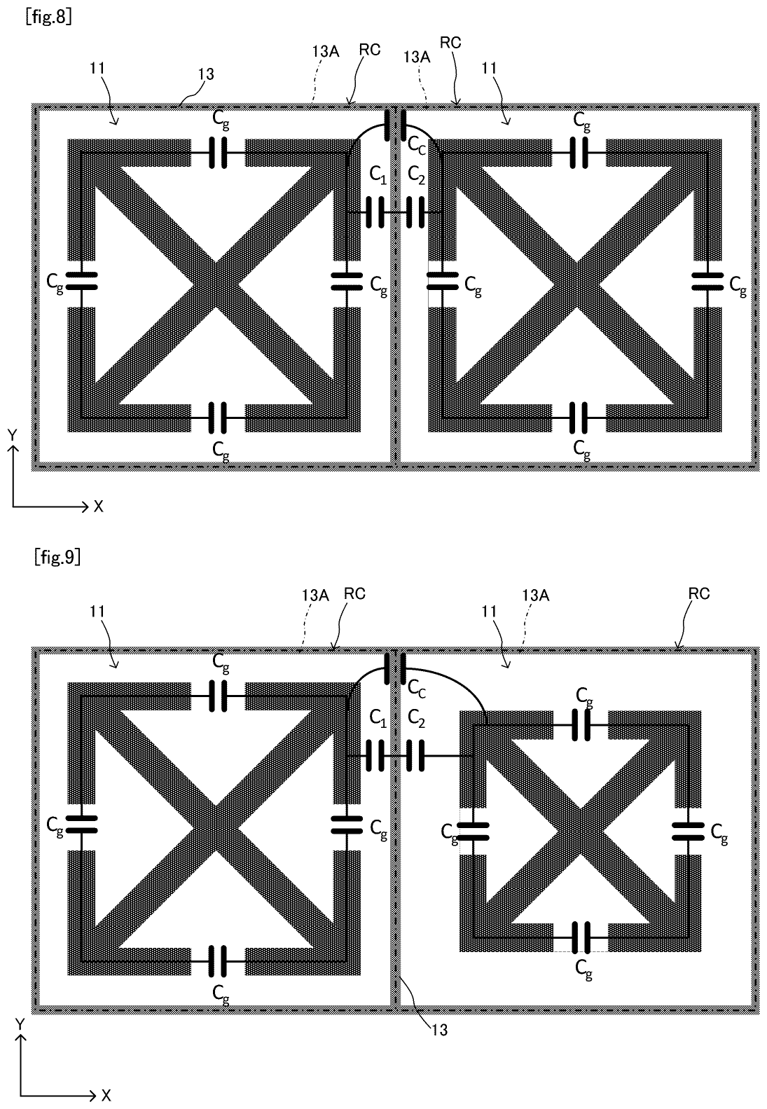

To alleviate this issue the conductor 13 is introduced during the design of the geometry of each cell 11 to divide the coupling capacitance CC between adjacent cells 11 into two or more separate capacitances, as shown in FIG. 8. The same geometry cells 11 are surrounded by the frames 13A of the conductor 13 that has mesh shape and the conductor 13 splits the total capacitance CC between two cells 11 into two separate capacitances, a one cell-frame capacitance (C1), and the other cell-frame capacitance (C2). For the case in which cells 11 have the same geometry (size), the value of C1=C2. If different size cells 11 are combined, the C1≠C2.

As shown in FIG. 9, the combination of different geometry (size) metamaterial cells in the beamformer 10 generally results in the change of the capacitance, C1≠C2. In FIG. 9, due to the separation of individual cells 11 by the conductor 13, the geometry change of the cell 11 has a negligible effect on neighbor cells 11 and the geometry change effects are contained within the optimized resonant cell Z. In FIG. 8 and FIG. 9, the coupling capacitance CC still exists; however, since the conductor 13 introduced the separation effect between cells 11, its effect was significantly decreased and can be omitted.

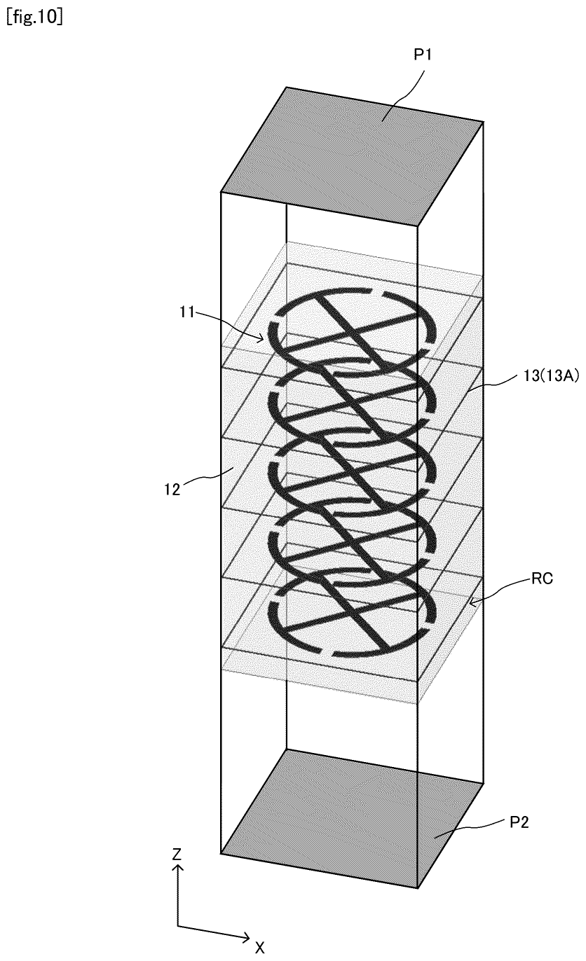

FIG. 10 shows the schematic of a simulated cell 11 used in this embodiment, tuned for a 300 GHz frequency band. In this embodiment, round cells 11 are used. The dielectric material 12 used in the simulations is benzocyclobutene (BCB) with a dielectric constant of εr1=2.47, μ=1 and tangent loss of tanδ=0.007, which are typical values of BCB material at millimeter-wave bands. A total thickness of 0.74 mm was used. The cell 11 and the conductors 13 were composed of Au. In FIG. 10, the cell 11 and the conductors 13 are placed horizontally, normal to the incident EM wave, radiated from PORT P1, and received at PORT P2. The cell 11 was oriented along the X-axis in a way to allow coupling of the electric field (E) component to the cell 11, and induce the resonance. The properties of BCB material are based on commercially available data and measurements at millimeter-wave bands.

In this simulation, a time-domain solver was used with normal incidence and periodic boundary conditions, with the electric component of the EM wave along the X-axis. With the assumption that the period of the cells 11 is constant, the geometrical parameters of cell 11, such as gap size, cell size, width, etc. were optimized to achieve a high transmission coefficient above S21 of S-parameters <−3 dB for a wide range of cell size and phase shift amount.

Round Jerusalem cross cells 11 were composed of a 500-μm-thick Au thin film that can be fabricated directly on the BCB, using magnetron sputtering, electron beam evaporation, and other methods. The parameters of the constant cells 11 are: the gap size g=25 μm, the width of the metamaterial lines is w=20 μm. For the cell 11 without the conductor 13, the cell period size is px=py=380 μm, the distance between each metamaterial layer is 170 μm, and additional top and bottom layers of dielectric materials 12 are 20 μm each (Total thickness of 0.72 mm). For the cell Z, the cell period is increased to px=py=400 μm, the distance between each metamaterial layer is 160 μm, and the additional top and bottom layers of dielectric material 12 are 50 μm each (Total thickness of 0.74 mm). The width of the conductor 13 is w2=4 μm.

The above parameters were obtained by the cell optimization process for a high transmission coefficient S21 at 300 GHz, above −3 dB, for different values of cell 11 size (radius R in this embodiment). The high transmission coefficient above −3 dB was kept in the 360 degrees phase variation region.

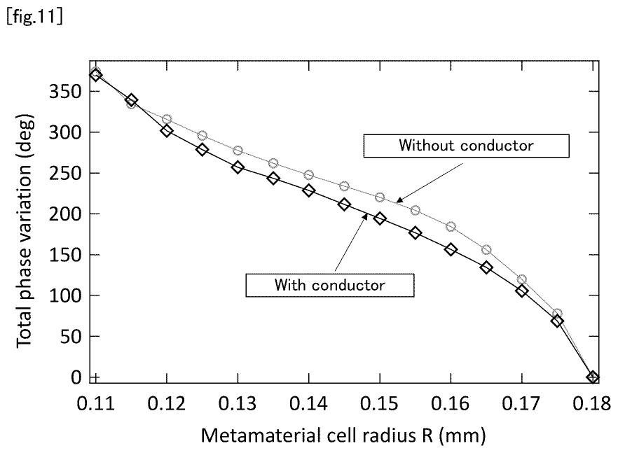

FIG. 11 shows total phase variation for the change of the size (radius R) of cells 11, with and without conductor 13. Individually designed and simulated cells 11 with different radius R, between 0.11-0.18 mm in this example, produce different amounts of the phase shift (phase variation). Generally, metamaterial cells are optimized to exhibit a 360 degrees (2π) phase shift in the high transmission range above −3 dB. Cells 11 with different geometries (sizes) and phase shift amounts are then combined in the beamformer 10, to exhibit a desired beamsteering angle of the incident EM wave.

In FIG. 1, the 5 cells 11A to 11E were used with the phase difference of Δφ=72 degrees between adjacent cells 11, to provide a 32-degree steering angle for beamforming. In this embodiment, the incident EM wave is steered in the X-Y plane; thus, the resonant cells Z are organized so a gradual variation of the phase in the X-direction is equal to Δφ. The incident wave is transmitted with phase variation which causes the steering of the combined output wave. Since the beamforming is only in a single plane, it was assumed that the elevation E=0, and azimuth A=θ, where θ is the steering angle of the combined output wave.

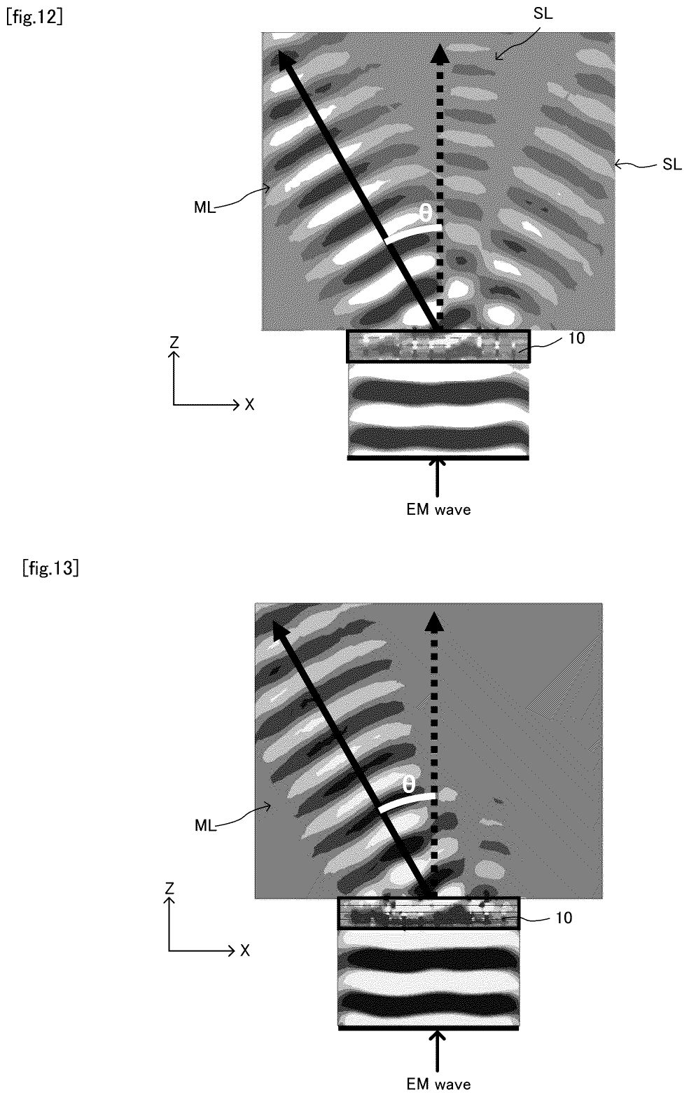

FIG. 12 and FIG. 13 show the simulated signal (EM wave) propagation through the beamformer 10 without and with the conductor 13, respectively. In these simulations to validate the designed metamaterial cells 11 with the conductor 13, beamformer 10 is used with the size of 11×5 multilayer cell elements. The incident EM wave from the millimeter-wave radiation source is directed to the beamformer 10 and then transmitted through. Due to the different phase shifts caused by the different radius of the cells 11, the combined EM wave is directed at an angle θ. In FIG. 12 (no conductor 13), except the main combined output wave lobe ML, two large additional side lobes SL were also generated. In FIG. 13 (with conductor 13), the main combined output wave ML, in other words, directional outgoing EM wave is wider and the side lobes were significantly decreased, comparing to FIG. 12. Thus, the passive beamformer 10 with conductor 13 reduces capacitance disturbances between cells 11 with different geometry, thereby side lobes can be reduced and the directivity of the beamforming beam (outgoing EM wave) can be improved.

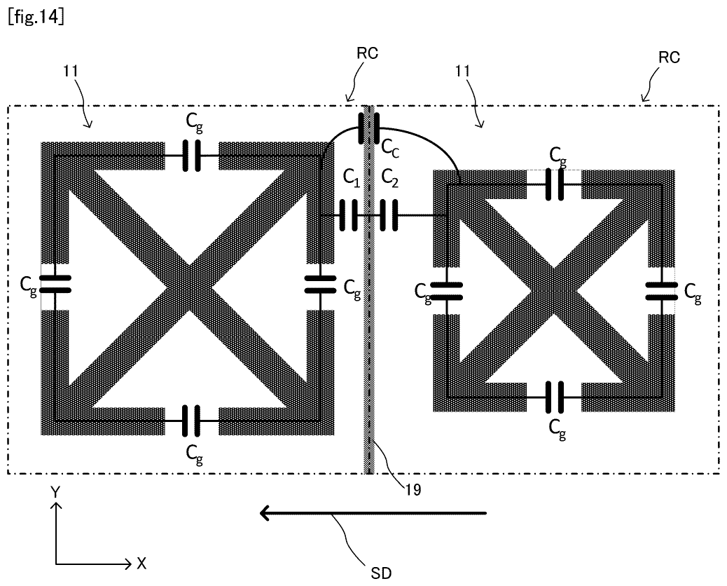

The mesh-shaped conductor 13 may be replaced by a straight linear shape conductor 19 as shown in FIG. 14. In some applications, mainly reflective beamformers, the requirement for millimeter wave beamforming is low and only one direction of the output combined wave is needed. For this reason, portions of conductor 13 may be omitted to simplify the structure and provide design flexibility. As shown in FIG. 14, conductor 19 extends along a direction orthogonal to the beam steering direction SD (direction to be directed). The conductors 19 can be placed between cells 11 of different geometry (especially size). The conductors 19 should extend along the direction in which cells 11 of the same geometry are aligned. In unidirectional beamforming, if individual cells are designed with different sizes to achieve different phase shift amounts, the result is that the neighboring cells change only in one direction. In FIG. 14, since conductors in one direction are not needed, further features such as connected cells and periodic gratings can be added when metamaterials are designed. To further simplify the design, the continuous conductors 19 may be changed to discontinuous conductors at the expense of a small decrease in the reliability of the beamforming device due to increased coupling capacitance interaction between the cells. In that case, the length of the conductor will be smaller than the size of the periodic cell Px or Py.

Although the invention has been described above with reference to embodiments and variations, the invention is not limited to the above embodiments and variations. For example, the present invention includes various modifications to the above embodiments and variations that can be understood by those skilled in the art within the scope of the technical concept of the invention. Each of the configurations listed in the above embodiments and variations can be combined as appropriate to the extent that there is no contradiction.

### REFERENCE SIGNS LIST

10 . . . Beamformer, 11A-11E . . . conductive metamaterial cell, 11 . . . conductive metamaterial cell, 12 . . . filling dielectric material 13 . . . conductor 13, Z . . . resonant cell.

1-6. (canceled)

7. A beamformer for directing an incident electromagnetic wave, comprising:
a first conductive metamaterial cell configured to shift a phase of a first portion of the electromagnetic wave;
a second conductive metamaterial cell located adjacent to the first conductive metamaterial cell, having a different geometry than the first conductive metamaterial cell, and configured to shift a phase of a second portion of the electromagnetic wave; and
a conductor including at least a portion disposed between the first conductive metamaterial cell and the second conductive metamaterial cell.

8. The beamformer according to claim 7, wherein the conductor is formed in a mesh shape surrounding the first conductive metamaterial cell and surrounding the second conductive metamaterial cell.

9. The beamformer according to claim 7, wherein
the conductor is formed in a linear shape that does not surround both the first conductive metamaterial cell and the second conductive metamaterial cell.

10. The beamformer according to claim 7, comprising:
a first cell group including first cells arranged along a predetermined direction, each of the first cells being the first conductive metamaterial cell; and
a second cell group including second cells arranged along the predetermined direction, each of the second cells being the second conductive metamaterial cell, and located next to the first cell group; wherein
the portion of the conductor is located between the first cell group and the second cell group and extends along the predetermined direction.

11. The beamformer according to claim 7, further comprising:
a dielectric material filled between the first conductive metamaterial cell and the second conductive metamaterial cell.

12. The beamformer according to claim 7, wherein the conductor divides a coupling capacitance between the first conductive metamaterial cell and the second conductive metamaterial cell.

13. The beamformer according to claim 7, wherein the beamformer is configured to operate in a millimeter-wave frequency range.

14. The beamformer according to claim 7, wherein the beamformer comprises multiple layers of conductive metamaterial cells.

15. The beamformer according to claim 7, wherein the first conductive metamaterial cell and the second conductive metamaterial cell have different sizes.

16. The beamformer according to claim 7, wherein the beamformer is a passive beamformer.

17. The beamformer according to claim 7, further comprising:
a conductive reflective layer disposed on a side of the beamformer opposite to a side on which the electromagnetic wave is incident.

18. The beamformer according to claim 7, wherein the first conductive metamaterial cell and the second conductive metamaterial cell are configured to provide a phase difference between adjacent cells to achieve a predetermined steering angle for the electromagnetic wave.

19. The beamformer according to claim 7, wherein the conductor is configured to reduce side lobes in the directed electromagnetic wave.

20. The beamformer according to claim 7, wherein the first conductive metamaterial cell and the second conductive metamaterial cell are round Jerusalem cross cells.

21. A multi-layer beamformer for directing an incident electromagnetic wave, comprising:
a plurality of conductive metamaterial cell layers, each layer comprising:
a first conductive metamaterial cell configured to shift a phase of a first portion of the electromagnetic wave;
a second conductive metamaterial cell located adjacent to the first conductive metamaterial cell, having a different geometry than the first conductive metamaterial cell, and configured to shift a phase of a second portion of the electromagnetic wave; and
a conductor including at least a portion disposed between the first conductive metamaterial cell and the second conductive metamaterial cell;
a dielectric material disposed between adjacent conductive metamaterial cell layers; and
wherein the plurality of conductive metamaterial cell layers are configured to have a gradual variation of phase shift in a predetermined direction.

22. The multi-layer beamformer according to claim 21, wherein the first conductive metamaterial cell and the second conductive metamaterial cell in each layer are round Jerusalem cross cells.

23. The multi-layer beamformer according to claim 21, wherein the conductor in each layer is formed in a mesh shape surrounding the first conductive metamaterial cell and the second conductive metamaterial cell.

24. The multi-layer beamformer according to claim 21, wherein the beamformer is configured to operate in a millimeter-wave frequency range.

25. The multi-layer beamformer according to claim 21, wherein the first conductive metamaterial cell and the second conductive metamaterial cell in each layer have different sizes configured to achieve different phase shift amounts.
